(19) United States
(12) Patent Application Publication
(10) Pub. No.: US 2019/0096224 A1
(43) Pub. Date: Mar. 28, 2019

(54) A DEVICE FOR CORRECT FEEDING POSTURE

(71) Applicants: Afik SHOHAM, Haifa (IL); Avraham SAGRON, Haifa (IL); Mor ELMODAI, Caesarea (IL); Zeev FRISHMAN, Netanya (IL)

(72) Inventors: Afik SHOHAM, Haifa (IL); Avraham SAGRON, Haifa (IL)

(21) Appl. No.: 16/077,492

(22) PCT Filed: Sep. 6, 2016
(86) PCT No.: PCT/IL2016/050981

§ 371 Date: Aug. 13, 2018

(30) Foreign Application Priority Data
Sep. 10, 2015 (IL) 241514

(51) Int. Cl. G08B 21/18; A61J 9/02; A61J 11/00

(52) U.S. Cl. CPC G08B 21/182; A61J 2200/74; A61J 11/00; A61J 9/02

(57) ABSTRACT

A device for notifying about a correct feeding posture of an infant with a feeding apparatus, said device comprising: At least one tilting means sensor for sensing the tilt angle of said feeding apparatus; an output means for alerting when said feeding apparatus is in the correct feeding posture; wherein, said device is attached to said feeding apparatus and according to the sensing of said tilting means sensor the output means alerts whether the feeding apparatus feeding posture is in the correct feeding posture.

### FIELD OF THE INVENTION

The present invention relates to baby bottles, in particular a device for correct feeding posture of babies.

### BACKGROUND OF THE INVENTION

A correct feeding posture is very important in particular for infants while feeding Infants should feed from a bottle at the same posture as an adult drinks from a glass. Lying down and drinking is not normal, and even adults may choke doing so. On the other hand, adults always make sure to lift their glass high enough making sure liquid flows into their mouth and not air. When dealing with a feeding infant, there are risks of an incorrect feeding posture for example; bottle-feeding while lying back too far may cause choking, tooth decay, ear infection and tonsil infection. A baby can suffocate from liquid dripping into his mouth. Babies who fall asleep while bottle-feeding can draw liquid into their lungs (and in extreme cases drown in their sleep). They might then choke or inhale food. This is more dangerous for a baby than it is for an adult, because the baby isn't as good at waking up if something interferes with his breathing. Although it's more likely that the baby will cough and be uncomfortable, it is better to avoid the risk. Tooth decay, rotting may happen in the mouth from static food within the mouth. Milk is quite high in sugar. Soaking an infant's teeth in milk overnight can cause tooth decay. Tooth decay can cause pain, infection and even affect a childs growth. Severe decay in baby teeth can have serious consequences for the child's speech and jaw development. Ear infection, when a baby drinks lying down, milk can flow through to the ear cavity, which can cause ear infections. Not lifting the bottle high enough may cause consumption of air, resulting in unwanted gases in the stomach. This will make a baby restless and even in some cases cause reflux, colic and diarrhea.

Therefore, one of the objects of the present invention is to provide a device that could fit onto a conventional baby bottle and monitor and alert when a baby's feeding posture is incorrect.

Yet another object of the present invention is to provide a device that can notify a user when the baby is feeding in the correct posture.

Yet another object of the present invention is to provide a device that can prevent all the aforementioned drawbacks and risks of incorrect posture when dealing with a feeding infant

An internet Blog, “http://blog.slowcontrol.com/?p=110” discloses an apparatus for Baby bottle to track how much and how fast baby is drinking. It gives an adult feedback on how a baby should hold properly the bottle so baby wouldn't swallow air and let the adult know if a lump is clogging the bottle.

Knowing precisely how to feed a baby, this apparatus improves significantly the baby's chances of being healthy and limited Reflux, colic and diarrhoea risks.

A baby feeding posture using pillows for adjusting the baby's head angle for proper elevation of baby's head are well known and are addressed for example in U.S. Pat. No. 7,111,347, US 20020023301 and U.S. Pat. No. 6,658,681.

U.S. Pat. No. 7,111,347 disclose a nursing pillow which is a firm foam wedge with feeding surfaces covered in softer, cushioning foam. The pillow itself supports baby and is angled to encourage proper elevation of baby's head necessary for good digestion and proper alignment of baby's mouth and mother's nipple. The outer layer of cushioning foam supports and cradles the baby while reducing the amount of effort required by the mother. The pillow has two covers: one waterproof inner cover and one removable, washable outer cover with a carrying handle.

US 20020023301 discloses A nursing pillow for supporting an infant on the lap of a user includes a main pillow body having a lower surface and an opposed upper surface interconnected by a front edge, a rear edge and a pair of opposed sides. The pillow body includes a mid portion with a first end and a second end. The upper surface of the mid portion slopes downwardly from side-to-side such that the upper surface of mid portion is higher at the first end and lower at the second end. The pillow body also includes a side portion adjacent the second end of the mid portion. The upper surface of the side portion is raised relative to the second end of the mid portion such that the upper surface of the pillow body steps upwardly from the second end of the mid portion to the side portion.

U.S. Pat. No. 6,658,681 discloses a nursing pillow has a flexible, positionable spine that allows the pillow to be deformed into a number of stable shapes. The spine is enclosed within a resilient body forming a medial region and first and second cantilever arms extending from opposite ends of the medial region to define a central opening between the arms in an unloaded, nominal shape. The spine is of sufficient stiffness to keep the pillow from returning from an adjusted shape to its nominal shape when unloaded. The spine may be formed of articulating links, or a malleable rod.

Musical baby bottles that contain music players for providing soothing music when they are tilted to calm a distressed infant are well known. Such issues are addressed for example in US2013324006 and U.S. Pat. No. 7,134,932.

US2013324006 discloses “Little Soothers” is a plush animal that slides onto an object and plays music. It is activated (plays music) when tilted or shaken. A sound module is located inside the “head” of “Little Soothers”. Sound plays for approximately 60 seconds. Royalty free children nursery rhymes plays through the sound module. Recordable sound module, which can record music, sounds or voices of the users' preference, will be available. Sound module is waterproof “Little Soothers” is machine washable. The center of “Little Soothers” is elastic. The head, arms and legs of “Little Soothers” is made out of material used in stuffed animals.

U.S. Pat. No. 7,134,932 discloses a musical baby with an omnidirectional, gravity-operated switching mechanism for turning a musical player on and off, depending upon the orientation of the bottle. The infant nursing bottle employs a liquid container and a base containing the electrical switching mechanism releaseably attached to the bottom of the liquid container, such as by a threaded connection. A hollow cavity is defined within the structure of the base. The cavity has an inclined floor that slopes from the periphery of the cavity toward the axial center of the base. A detent recess is located at the axial center of the base and an electrical switch having a switch actuator is located at the detent. A sphere within the cavity rolls by gravity across the inclined surface of the cavity floor. The sphere lodges in the detent when the base and liquid container supported upon the base are oriented vertically upright, as when placed upon a horizontal surface. The base and liquid container are tilted, as when feeding a baby the sphere dislodges from the detent thereby closing a circuit from a battery to the music player to play a lullaby or other calming music.

U.S. Pat. No. 5,767,775 describes a device and method for sensing fluid characteristics, including level, temperature, pH and chemistry, comprises a switch affixed to or embedded in a container of a size, shape and density such that said container floats stably in said liquid until a predetermined level is reached the container tilts so as to operate the switch when the liquid drops below or increases above a predetermined level. The device may contain additional sensors which measure and report other characteristics of the liquid, such as temperature, pH, viscosity, chemistry or biochemistry.

US2007188338 describes a tilt sensor apparatus having one or more tilt sensors. Each tilt sensor includes a conductive element entrapped within an opening formed through a middle planar substrate. The opening is surrounded by an opening wall which is entirely covered by a conductor. A conductive star pattern is formed on a top planar substrate, and a conductive star pattern is formed on a bottom planar substrate. The star patterns are positioned at opposing ends of the opening. The conductive element moves within the opening as the apparatus is tilted. An interrupt-driven control circuit is configured to indicate a change in orientation only when a short is first detected across a contact pair that corresponds to an orientation opposite to a currently-indicated orientation.

System and method for evaluating the infant feeding performance of is addressed for example in US2011251510 and WO2008127733.

US2011251510 discloses devices, systems and methods for measuring infant feeding performance. The device includes a body portion, a respiration sensing device for receiving respiration and an integrated circuit disposed in the body portion and electrically connected to the respiration sensing device. The body portion has a first end for receiving a fluid, a second end for passing fluid to a feeding nipple, and a conduit in fluid communication with the first end and the second end. The respiration sensing device is mechanically coupled to the body portion and is mateable with the feeding nipple. The respiration sensing device generates a signal representing a variation in temperature or airflow of the respiration during a feeding session. The integrated circuit receives the temperature or airflow signal determines a respiration pattern over the feeding session indicative of the infant feeding performance.

WO2008127733 discloses A method and system for computing a relative score indicative of an individual infant's feeding performance based, at least in part, upon a comparison of one or more feeding factor measurements of the individual infant with a corresponding databased metric that is derived from a population-based sample of infants, wherein the comparison optionally provides a statistical association between normative metric values and adverse outcomes recorded for the same population-based sample and, thereby, a means for assessing the tested infant's risk for said adverse outcomes.

A system for diagnosing or monitoring sucking/swallowing/breathing competence of an infant is addressed for example in U.S. Pat. No. 6,033,367, the system includes a processor that receives a sensed signal from a breath sensor, and develops an output for intraoral tactile or flow control feedback. In a feeding the processor applies the signal to control a liquid feeding valve which supplies nutrients through a feeding nipple. In various control regimens, the processor acts as a safety device and operates to restrict or close the valve to reduce flow when slowing or cessation of breath is detected, or acts as a training device to set or pace, or initially to develop basic competence, at an appropriate rate.

### SUMMARY OF THE INVENTION

The present invention relates to baby bottles, in particular a device for monitoring correct feeding posture of feeding babies. This is monitored through the angle of the bottle.

In accordance with an embodiment of the present invention there is provided a device for notifying about a correct feeding posture with a feeding bottle. The device includes at least one tilting means sensor for sensing the tilt angle of the feeding bottle. The device further includes an output means for alerting when the feeding bottle is in the correct feeding posture. The device is attached to the bottle and according to the sensing of the tilting means sensor the output means alerts whether the feeding posture is correct.

### BRIEF DESCRIPTION OF THE DRAWINGS

The invention may be understood upon reading of the following detailed description of non-limiting exemplary embodiments thereof, with reference to the following drawings, in which:

FIG. 1 is a perspective view of a device for correct feeding posture of baby bottles in accordance of the present invention fit on a conventional baby bottle;

FIG. 2 is a perspective view of the device shown in FIG. 1;

FIG. 3 is a perspective schematic view of some of the parts of the device shown in FIG. 1;

FIG. 4 is a block diagram describing the electronic components that may include in the device in accordance of some embodiments of the present invention;

FIG. 5 is a perspective view illustrating a baby fed from a baby bottle, fit on the baby bottle the device shown in FIG. 1, where the baby is fed in zone B of the correct feeding posture; and

FIG. 6 is a schematic block diagram describing the communications between the device for correct feeding posture of baby bottles and the docking station of the present invention with target devices.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

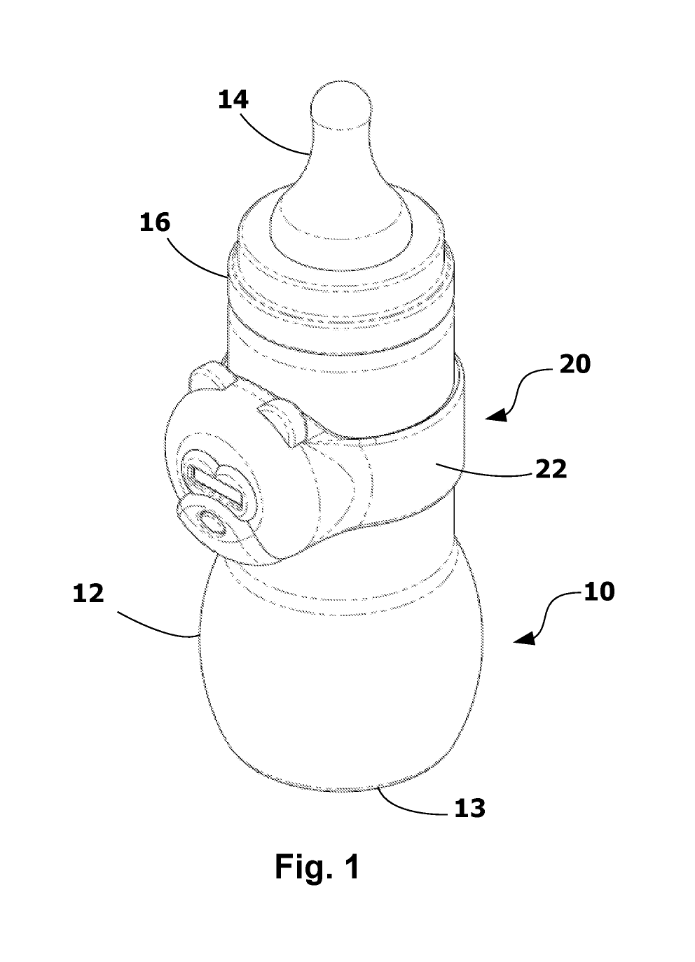

Referring to FIG. 1, there is shown a conventional feeding apparatus such as but not limited to baby bottle 10 formed as elongated, tubular container 12 made of glass or plastic having a closed bottom end 13 and an open mouth at the opposite top end. Rubber or silicon nipple 14 is releaseably secured to the open, top end of a conventional bottle 10 by means of annular plastic collar 16 which provide a liquid-tight seal at the mouth of the bottle. Conventional infant feeding bottles of this type may be cylindrical in cross-section shape, but sometimes formed polygonal outer cross-sectional configuration. A device 20 of the present invention for notifying about a correct feeding posture is fit on the bottle 10.

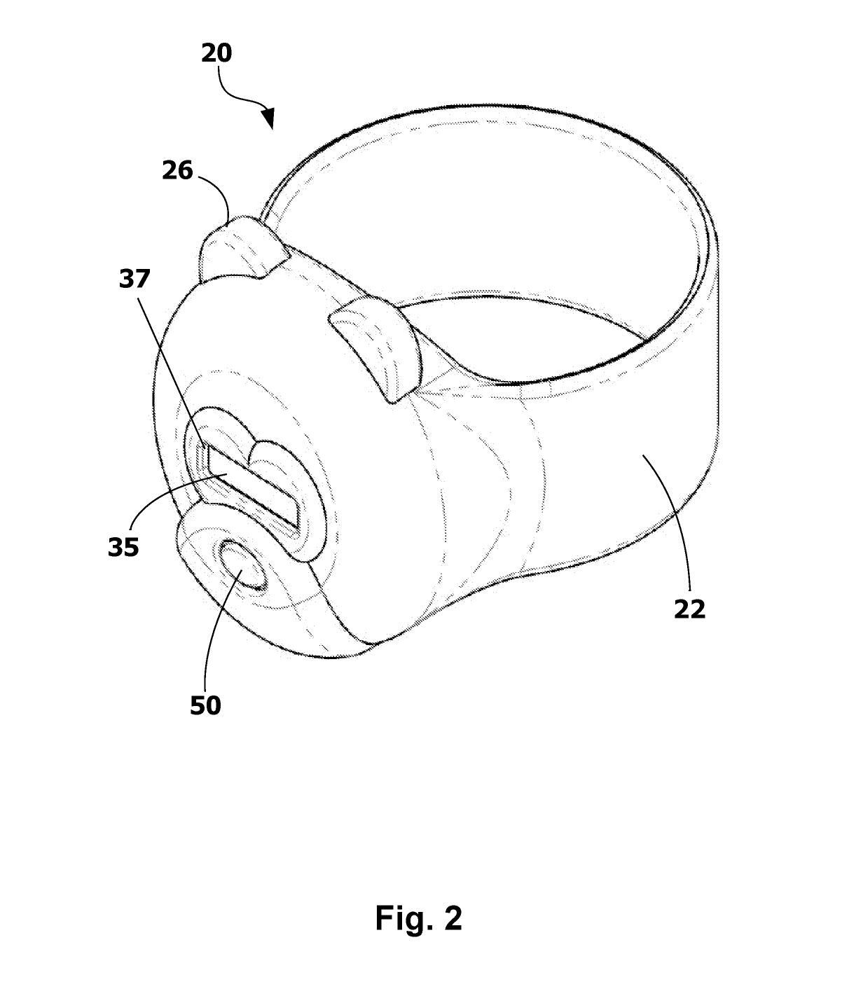

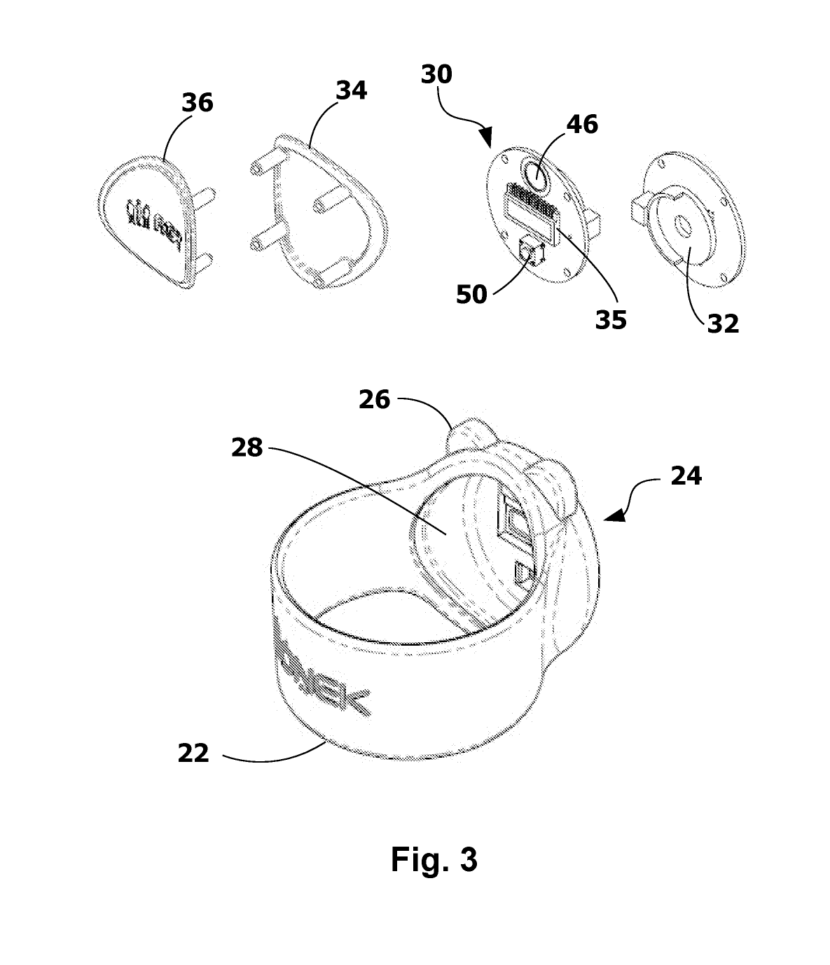

Referring also to FIG. 2 and FIG. 3, device 20 which can be a water proof device includes in accordance of some embodiments of the present invention a fastener such as but not limited to a strap 22 that can slide onto the baby bottle 10. The strap 22 of the device 20 can be elastic, so it may expand to fit the baby bottle 10. Other suitable fasteners known in the prior art such as but not limited to a snap fastener and clip straps can be used for fastening the device 20 of the present invention onto the conventional baby bottle 10. Device 20 further includes a head portion 24 attached to the strap 22 and thereby fastened to bottle 10 by the strap 22. The head portion 24 may have an attractive design for example of a round face with ears 26 that resembles a face of a cute animal such as a cat, dog or a panda bear. In accordance of another embodiment of the present the device 20 of the present invention may have other shapes such as that the device 20 can be secured to the bottom end of a conventional baby bottle, not shown. In accordance of another embodiment of the present invention the device of the present invention can be integrated into a baby bottle, not shown, for example the integration of a baby bottle with the device of the present invention can be made during the manufacturing process of the bottle.

The rear portion of head 24 has a recess 28 to house one or more printed circuit board (PCB) 30 the rear portion of head 24 further housing a battery, not shown, and a battery housing 32. The recess 28 is closed by a cover 34. A detachable cover 36 can be attached to cover 34 for example for replacing a logo or for providing a unique identification of the product 20 to the user. The printed circuit board (PCB) 30 may include data output means such as but not limited to a liquid crystal display (LCD) 35 which can be read directly from an aperture of head 24. Another output means can be music, lights or sound players. The PCB may be capsulated separately and then “snapped” into the exterior band/housing.

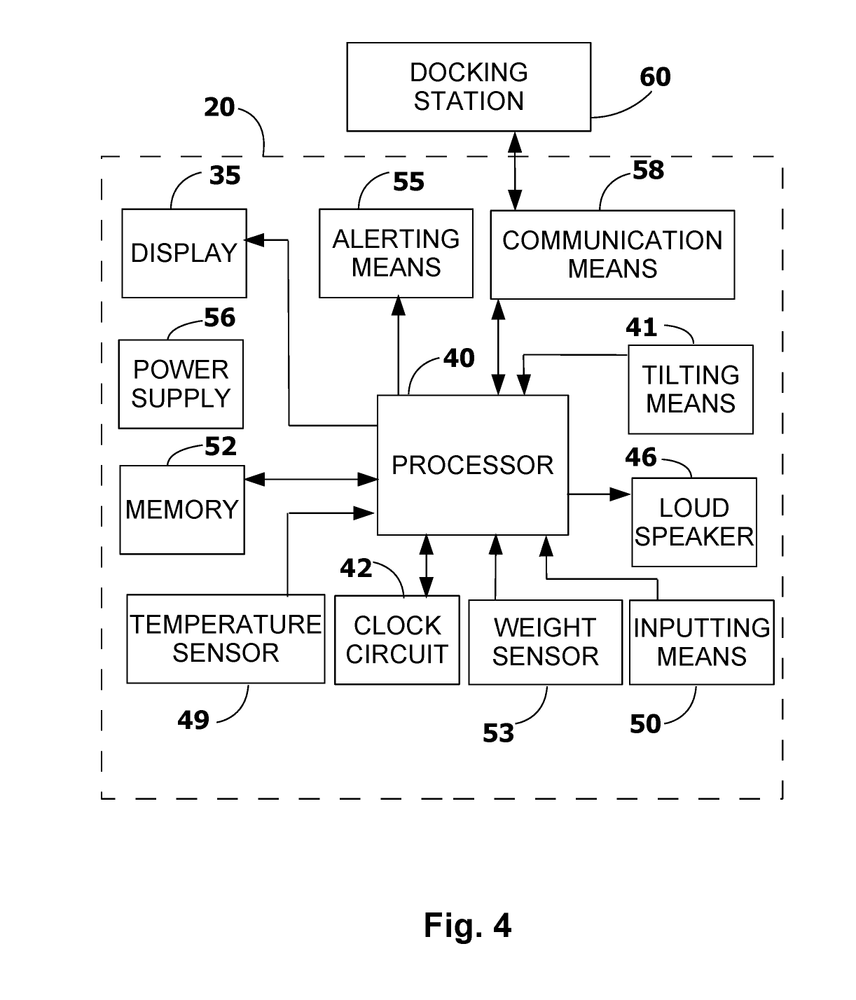

Referring now to FIG. 4 there is shown a block diagram describing the electronic components that may included in the PCB of device 20 in accordance of some embodiments of the present invention, the PCB may further include tilting sensor means as known in the art such as but not limited to accelerometers, gravitational sensors and gyroscopes 41. The printed circuit board (PCB) 30 may further include data input means such as but not limited to push buttons or a touch screen, not shown. The parent or other adult that uses the device can configure the device and can change the display screens of display 35 by pressing one or more buttons 50. The printed circuit board (PCB) 30 may further include data storage such as memory 52. The printed circuit board (PCB) 30 may further include clock circuit 42, temperature sensor 49 and weight detector 53. The weight detector 53 can be used for knowing how much food was consumed. Device 20 may further include a hardware module for running software and performing calculations such as a processor or microcontroller 40. The temperature sensor 49 is electrically connected to processor 40 for monitoring the liquid temperature inside the baby's bottle and alerting using the alerting means when the temperature is high. Extreme temperature of the liquid in the baby's bottle can be alerted using the monitoring system keeping the infant safe of burns and injury (via the display or other audio visual means). These sensors can be programmed to be in activation either constantly or only at a regular intervals. The device 20 may further includes a clap detector, baby bottles tend to “disappear”, for example a clapping sound can trigger a buzzer or sound and lights for easily finding the baby's bottle.

The processor 40 is connected to the clock circuit 42 that keeps time. The clock circuitry can be a clock circuit that counts time, and can be in the form of timer or counter that counts time or a module that keeps track of actual time. Utilizing the clock circuit enables for example to alert with alerting means 55 about the infant's food freshness in the bottle 10. For example after approximately one hour the nutritious values are lost and a fresh batch of infant food should be prepared for the baby. Monitoring the time for making another batch is simple by using the clock circuitry 42 as a timer. Non fresh bottle may harness deadly bacteria. Alerting means 55 such as but not limited to light emitting diodes (LEDs), sound players can be used for alerting when the baby bottle is not fresh. The sound player can be provided for example by a small musical chip, such as those featured in greeting cards. The digitally program chip is powered by a small battery and provides an audio output through a loud speaker 46. In another embodiment of the present invention the sound player signal can be generated for example by processor 40 with an appropriate program. The processor 40 is electrically connected to inputting means 50 and is configured to process signals received from the inputting means. Examples of inputting means 50, a touch screen display and push buttons. The electrical components of device 20 are powered by a power supply 56 which can be in the form of battery or rechargeable battery. Device 20 may further include an electrical opening contact to charge the chargeable battery or by induction.

Information such as feeding history data and feeding method data, for example, is stored and recalled from the storage device 52 such as memory that is electrically connected to the processor 40. The processor 40 is further connected to the display 35 for displaying information to the user. The processor 40 is also connected to a communication means 58 for communicating information between a docking station 60 and device 20. The docking station 60 may include communication means for communicating information between the docking station 60 and remote devices, such as Smart phones, home computers, tablets. The docking station communication means provides communication link with the remote devices which can include a wired communication such as USB, Ethernet cable, etc, or a wireless connection via local area network, Bluetooth communication protocol, or a cellular network. The processor 40 communicates with the storage device which configures the processor to implement the processes of the present invention.

The tilting sensor means 41 such as but not limited to gyroscopes, gravitational sensors, accelerometers, conductive inclinations sensors and Microelectromechanical systems (MEMS) inclinometers can be used for measuring the tilt angle of the infant bottle. An alerting means 55, such as audible alarm, a light source, alerts the parent and may discomfort the infant when the bottle is in the wrong angle. A wrong angle can be a low feeding angle that may cause a risk of baby's unwanted stomach gases and a high feeding angle may cause risks of baby's choking and suffocation, ear and tonsil infections, tooth decay and etc. The tilt sensor means according to some embodiment of the present invention is electrically connected to processor 40. However, in other embodiments of the present invention the processor 40 does not need to be included in the device system, the readings of the tilting sensor means 41 can go directly to the alerting means 55 or can go first to a simple electric circuitry such as a comparator and then the output of the comparator which indicates if the bottle feeding posture is correct, goes to the alerting means 55. As well this can be done by a simple mechanical mechanism without the use of complex electronics and data processing.

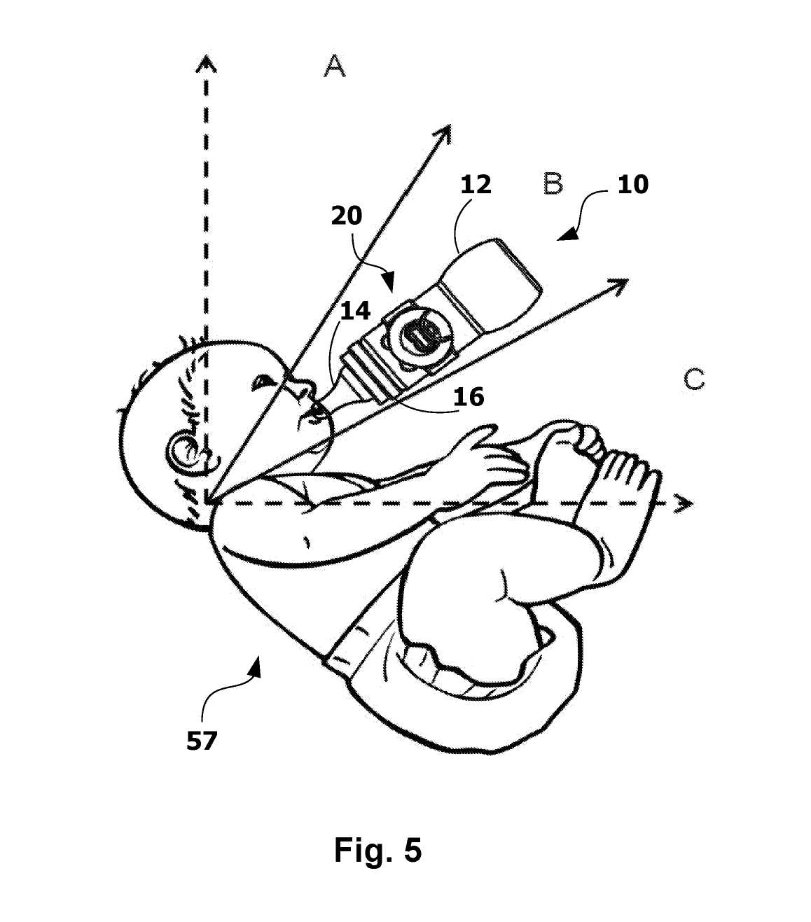

Referring also to FIG. 5, while feeding the baby 57 in a certain posture, if the bottle is lifted too high (zone A) a beeping sound alerts, indicating that the bottle is out of the safe zone. When the bottle is tilted in the “safe zone” (zone B) a light can indicate that the bottle feeding posture is within the borders of the “safe zone” (zone B). Optionally, music can be played while the bottle is in the safe zone. As long as the bottle is within the angle of the safe zone music is played. This stimulates the infant to feed in the proper posture. If the bottle is lifted too low (zone C) a beeping sound alerts (or visual lights) indicating that the bottle is out of the safe zone (zone B). When feeding the infant, tilt the bottle so the milk completely fills the nipple area. This decreases the amount of air that the baby is likely to take in (zone C), lessening their chances of having unwanted stomach gases.

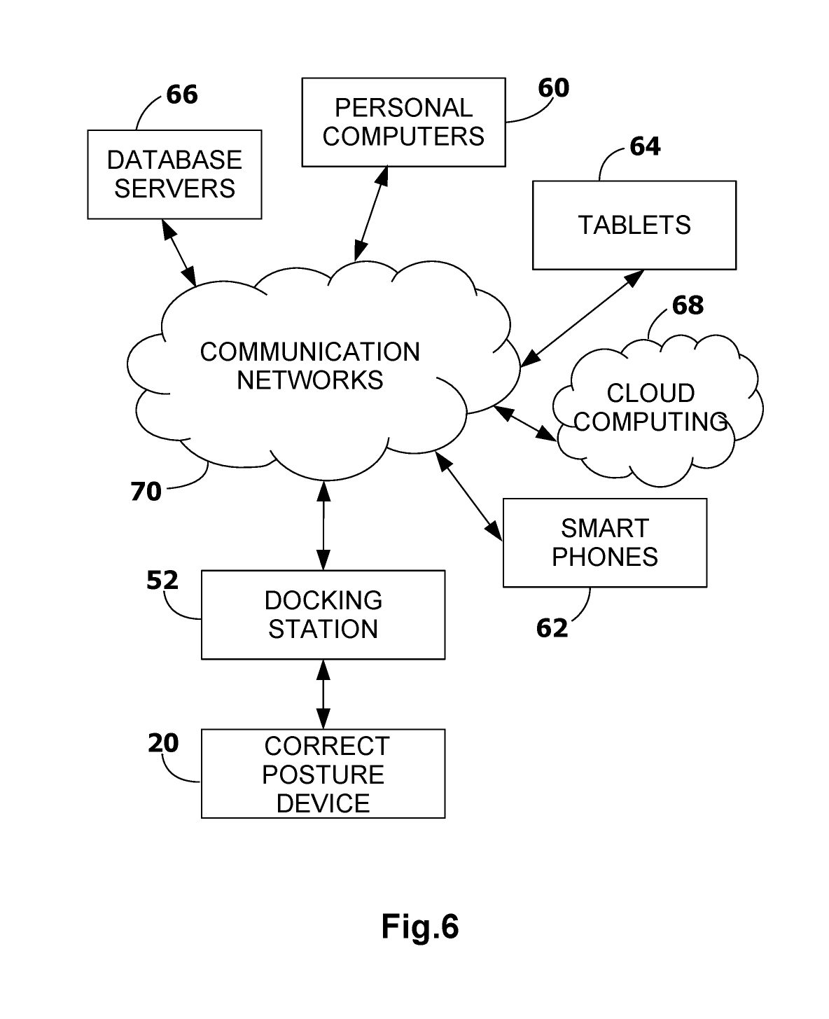

Referring to FIG. 6, the docking station may be used for charging the device 20. The docking station 60 may further includes a hardware frame and set of electrical connection interfaces that enable transferring and storing the data that were collected from the sensors of device 20 to the docking station 60. In some embodiments of the present the docking station 52 includes a communication means such as but not limited to cellular modem, Bluetooth transceiver and local area computing network (WI-FI). The docking station can connect to Wi-Fi/LAN network. The docking station can then communicates with target devices such as personal computers 60, mobile devices such as Smartphone 62, tablets 64 or can communicates with database servers 66 and cloud computing 68 through the communications networks such as but not limited to the Internet, the cellular network and the Public Switched Telephone Network (PSTN). The target devices may include application software to receive vital information regarding the baby's feeding habits. In some embodiments of the present invention the applications can be available through application distribution platform, such as the Apple App Store, Google Play, and Windows Phone Store. The applications can be downloaded from the platform to the target device. Applications/programs designed to run on the target devices can be used for providing to the user helpful information about the baby such as but not limited to feeding habits, to inform the baby parent when the baby emptied his bottle and to alert about risks that may happened when the baby interacts with a baby bottle for example when the feeding posture is incorrect. The docking station may further include a heating bay to heat and keep the food at a desired temperature. In some embodiments of the present invention a docking station is provided for electrically charging the device power energy.

It should be understood that in accordance with the preferred embodiment of the present invention the device 20 is radiation free meaning, no wireless data is transmitted and received from/to the device when the device is installed onto baby bottle.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1-26. (canceled)

27. A device comprising:
a titling sensor for sensing a title angle of a feeding apparatus utilized for feeding an infant;
a processor for determining whether the title angle is above a predetermined minimal angle and below a predetermined maximal angle;
a signaling module for issuing a signal in response to an instruction from said processor;
wherein, said device is configured in size and shape to be attached to the feeding apparatus.

28. The device of claim 27 further comprising a releasable fastener for fastening said device onto said feeding apparatus.

29. The device of claim 27, wherein said device is configured to be secured to a bottom portion of the feeding apparatus.

30. The device of claim 27, wherein said device is integrated into said feeding apparatus.

31. The device of claim 27, wherein said tilting sensor comprises at least one of a gyroscope and an accelerometer.

32. The device of claim 27, wherein said signaling module comprises at least one of a speaker, a Light-Emitting Diode (LED) and a screen display.

33. The device of claim 27, wherein said signaling module is configured to transmit the signal to a remote device, wherein the remote device is configured to alert a user of the remote device in response to receiving the signal.

34. The device of claim 27, wherein said signaling module is configured to provide a first sensible signal indicative of the feeding apparatus being positioned correctly and a second sensible signal indicative of the feeding apparatus being positioned incorrectly, wherein said processor is configured to instruct said signaling module to issue the first sensible signal in response to the tilt angle being above the predetermined minimal angle and below the predetermined maximal angle, wherein said processor is configured to instruct said signaling module to issue the second sensible signal in response to the tilt angle being below the predetermined minimal angle or above the predetermined maximal angle.

35. The device of claim 33, wherein the first sensible signal is a beeping sound or an emission of visual light, wherein the second sensible signal is a music.

36. The device of claim 27, wherein the feeding apparatus comprises a nipple for feeding the infant, wherein the feeding apparatus is configured so as to have liquidized food flow and fill the nipple completely when the feeding apparatus is above the predetermined minimal threshold.

37. The device of claim 27 further comprising a clock, wherein said processor is configured to track, using said clock, food freshness of food in the feeding apparatus.

38. The device of claim 27, wherein said device is operatively coupled to a data storage, wherein the data storage retaining feeding history data.

39. The device of claim 27 further comprises a temperature sensor for monitoring a liquid temperature inside the feeding apparatus, wherein said device is configured to issue an alert when the liquid temperature is above a threshold.

40. The device of claim 27 further comprising a sensor for determining an amount of liquid within the feeding apparatus.

41. The device of claim 27, wherein the predetermined minimal angle is above zero degree angle with respect to a plane parallel to a ground plane, wherein the predetermined maximal angle is below ninety degrees angle with respect to the plane parallel to the ground plane.
